(19) United States
(12) Patent Application Publication
(10) Pub. No.: US 2016/0152400 A1
(43) Pub. Date: Jun. 2, 2016

(54) Hermetically sealed Microwave Package and Process

(71) Applicant: Juan Carlos Tinoco, Vadnais Heights, MN (US)

(72) Inventor: Juan Carlos Tinoco, Vadnais Heights, MN (US)

(73) Assignee: LaserSharp FlexPak Services, LLC, Vadnais Heights, MN (US)

(21) Appl. No.: 14/928,123

(22) Filed: Oct. 30, 2015

Related U.S. Application Data
(60) Provisional application No. 62/072,959, filed on Oct. 30, 2014.

(51) Int. Cl. B65D 81/34; B65D 79/00; B65C 5/02

(52) U.S. Cl. CPC B65D 81/3461; B65C 5/02; B65D 79/005; B65D 2581/3439

(57) ABSTRACT

A microwavable package is formed with venting mechanisms that are arranged in one of a number of different ways, and are covered with a pressure sensitive adhesive label. While the vents are covered with the pressure sensitive adhesive label, the package is hermetically sealed. The label protects the venting mechanisms from breakage due to product mishandling and abuses during storage and transportation. Prior to be cooked the consumer will remove or peel back the pressure sensitive adhesive label exposing or opening the venting mechanisms. Such vents can be of multiple different shapes, including a perforated shape whose center portion is removed or center portions sticks to the pressure sensitive adhesive label when the label is pulled back and removed from the package. The package is then placed in the oven or microwave and the product inside can be cooked safely. This method guarantees a reliable, safe designed, steam release and cook-in-the-bag mechanism that will always deliver a controllable process from the freezer to the table.

This application claims priority from Provisional application No. 62/072,959, filed Oct. 30, 2015, the entire contents of which are herewith incorporated by reference.

### BACKGROUND

Sealable packages can be used to hold food and other items that benefit from being sealed.

Microwave packages can be processed using microwaves in order to, for example, cook or heat the food in the package. In recent years, several companies have supplied a variety of microwavable packages. The present invention generally relates to the field of packaging for products. Typical products which can be packaged in this way include different kinds of food including frozen and perishable food. The specification refers to these packages as microwave packages, since the food is intended to be cooked using microwave power while the food is still in the package.

A venting or steam release mechanisms that is completely cut thru a packaging film can vent very well when cooked in the microwave. Users can be instructed to create such a steam release mechanism by piercing the package for example with a knife. Alternatively, it could be possible to leave a vent in the package. However, such a vent would not be hermetically sealed, and this could result in leakage and/or product contamination.

If there were a venting or steam release mechanisms that was scored or partially cut thru the packaging film, that could be leave a package hermetically sealed. However, that partially cut venting would likely not perform or vent properly when cooked in the microwave.

### SUMMARY

The present application describes a package where a vent is created using a laser or mechanical die, the vent is sealed under a pressure sensitive adhesive closure, and the vent is opened by peeling back the closure allowing the steam to be released when the product is cooked in the bag using a microwave or oven. The vent can be a scored shape, a die cut, slit, or perforation on the packaging film.

### BRIEF DESCRIPTION OF THE DRAWINGS

In the Drawings:

FIG. 1 shows an embodiment of an in-line label applicator with laser system for scoring, die cutting and/or perforating a packaging film according to the present embodiment to create a venting mechanism, and a pressure sensitive adhesive label is applied to cover the venting area;

FIG. 2 shows a packaging film, with a pressure sensitive adhesive label over a first perforated perforated arrangement according to the present application;

FIG. 3 shows a rigid container with lidding packaging film containing a pressure sensitive adhesive label over a perforated venting mechanism according to the present application;

FIG. 4 shows a packaging film, with a pressure sensitive adhesive label over a venting mechanism formed of laser scored circles;

FIG. 5 shows a pillow pouch using the venting mechanism of FIG. 4;

FIG. 6 shows the scored circles using the venting mechanism of FIG. 4, which are torn away from the package when the label is peeled back;

FIG. 7 shows a packaging film, with a pressure sensitive adhesive label over a venting embodiment where the vents are formed of slits;

FIG. 8 shows a pillow pouch with a pressure sensitive adhesive label over a venting mechanism formed of laser scored star-shaped vent;

FIGS. 9A-9 D show different ways of scoring, perforating or die cutting the packaging film using a laser to create a venting mechanism after the PSA label has been applied onto the Packaging Film.

### DETAILED DESCRIPTION

The embodiments described herein describe a hermetically sealed Microwavable package that is ready to vent by manually pulling a pressure sensitive adhesivetab that will open a venting mechanism to release steam when package is cooked in the oven or microwave, and a way of manufacturing such a package using packaging film. The packaging film material can be for example plastic material such as polyethylene or other packaging material. The packaging film material can be single polymer, multi-polymer, paper, folding carton, or multi-laminate structures.

The packaging material is sealed to form a package that is microwaveable.

The sealed package includes a vent formed of a precision pattern or shape to create a venting or steam release feature in combination with a pressure sensitive adhesive (PSA) label that maintains the package hermetically sealed until it is ready to cook. The invention guarantees both a hermetically sealed package prior to cooking and a reliable steam release and cook in the bag mechanism.

In one embodiment, the vent is created using a laser to score the package to create the pattern or shape in a location under the PSA label.

Another embodiment uses mechanical die cutting. The cutting is used to create a venting or steam release mechanism within the package that would otherwise burst when pressurized by the microwave. This venting mechanism is covered by a label that will maintain the package hermetically sealed until the product is ready to cook.

Embodiments can form the package as follows.

Preferably, first a Pressure sensitive label (PSA) Label is applied to the outer surface of the packaging film, then a pattern or shape is cut completely or to a certain depth on the inner surface of the packaging film so as to form a weakened area. The PSA labels are packaged in a roll format with a silicon coated carrier liner protecting the adhesive. The PSA label could be oriented to align with the packaging film in the web travel direction. In another embodiment, the label can be oriented in the Transverse travel direction. Inline label application is done using a label applicator, which usually has a label unwind, print registration sensor, label removal mechanism, application roller, and liner rewind. The roll with the PSA label runs through the label applicator, the PSA label gets released and applied to the outer surface of the packaging film, and the label carrier liner is rewound.

The packaging film also comes in a roll format, most often with multiple packages with printed graphics equally spaced across the film, and therefore is unwound and rewound continuously. The packaging film has printed marks to allow for accurate application of the PSA label in registration with the printed graphics on the packaging film. The packaging film could be also clear with no registration marks, in this case the PSA label is applied at a fixed distance or in a fixed repeat on the packaging film.

The PSA labels are applied to the outer surface of the packaging film. In this embodiment, the labels are applied in registration with printed graphics on the packaging film, while the web of packaging film is moving.

Depending on the material or structure of the packaging film, it may be required to cut completely thru the entire film structure. The consumer will peel back and remove the label prior to placing the package to cook the product in the microwave. The adhesive on the back of the label will adhere and grab to the cut shape or pattern and will expose the venting pattern or shape prior to being cooked. The label includes a pull tab and is larger than the venting pattern or shape area to keep that area hermetically sealed until the label is removed.

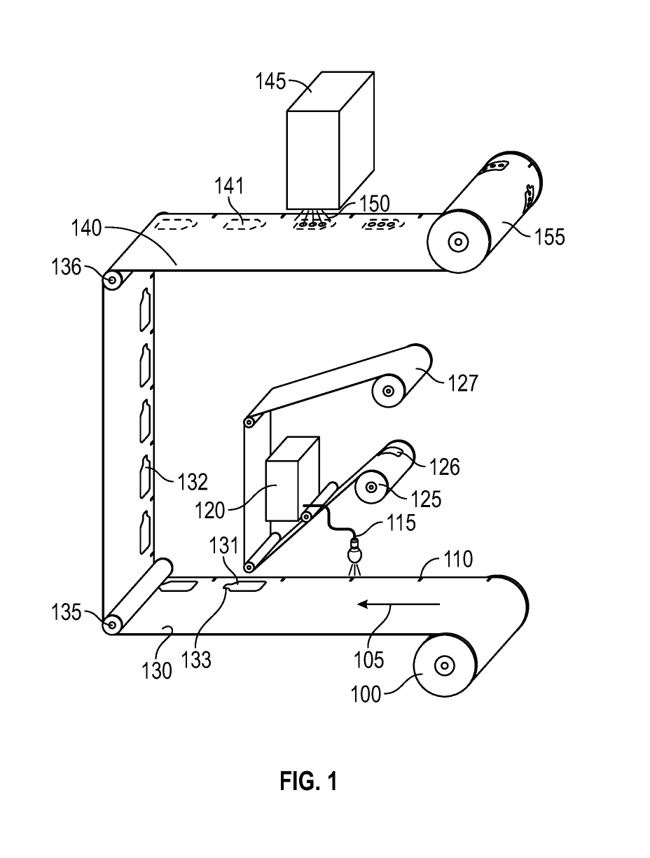

FIG. 1 illustrates the process used according to an embodiment to form the package. While FIG. 1 shows the use of an in-line laser system and label applicator, it should be understood that other systems of this type or an off-line system or a combination of systems, can also be used to create such package.

The initial packaging film is formed on a roll 100 which is unwound in the machine direction 105. In the embodiment, the roll includes registration marks 110 that can be used to set the size of the package. These registration marks 110 are sensed by a photosensor 115 which is connected to the label applicator 120. The label applicator is also on a roll 125 from which it is unwound. Each of the PSA labels 126 are on the label applicator. After the label is applied to the packaging film, it is rewound as carrier liner onto the rewind roll 127. The labels such as 126 are applied as labels 131 to the outer layer 130 of the packaging film. As can be seen in FIG. 1, a number of labels 131, 132 are equally spaced along this outer layer. The label may be applied ramdomly at any location or orientation or in registration within the package type or randomly.

The label and laser score can be completed in continuousor indexing mode. The label can be oriented in either the machine direction or transverse direction relative to the film.

The packaging film is then extended between idlers 135 to a location where the inner layer of the packaging film is processed by a laser system. This inner layer is the opposite layer from that on which the labels were applied. The labels or the rear surface of the labels are shown as 141. The laser system outputs a laser beam 150 that creates perforated holes or scored shapes for venting at locations on the inner surface corresponding to the labels on the outer surface. Subsequent to this processing by the laser, the packaging film is rewound onto rewind roll 155.

The finished roll 155 is shipped to the customer's packaging line where usually is formed into a pouch that will be filled and sealed with product.

In operation, the final product is used by a consumer, whereby the consumer removes the PSA label from the package by pulling up on a tab portion 133 of the label.

The adhesive on the back of the label seals the pattern prior to removal; and exposes the vents 151 when removed, prior to being cooked. Then, the consumer will place the package in the microwave with the venting or steam release pattern facing up. At this time the food in the package is ready to cook.

A number of different perforation configurations can be used as the venting mechanism for the vents 151. All of these venting mechanisms are in a location on the packaging film over which the pressure sensitive adhesive label will be located.

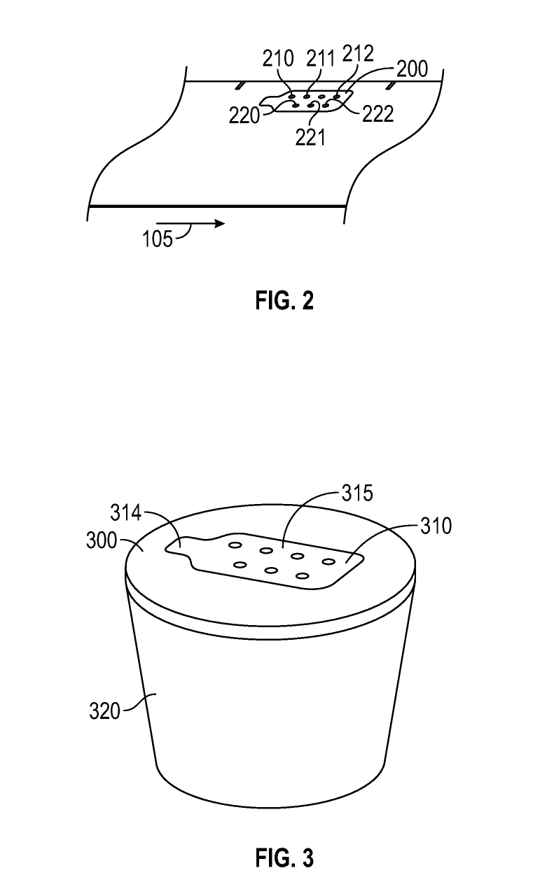

FIG. 2 shows a first embodiment where the perforations that form the venting mechanism are formed of six separate holes 210, 211, 212 forming a first row, and 220, 221, 222 forming a second row that is offset from the first row. The perforations of the second row are offset in both the machine direction 105 and also in the direction perpendicular to the machine direction. In this way, a triangle is formed between any 3 adjacent venting perforations such as 210, 220, 211. The packaging film material with the pressure sensitive adhesive label thereon can then be used to form any kind of package type.

FIG. 3 shows the perforated package forming the top 300 of a rigid container 320. The top 300 includes the label system is formed such as in FIG. 2, including a pressure sensitive adhesive label 310 with pull tab 311, and the venting mechanism 315. Note in the venting mechanism 315, there are 2 rows of offset events, but a total of 7 vents in this embodiment.

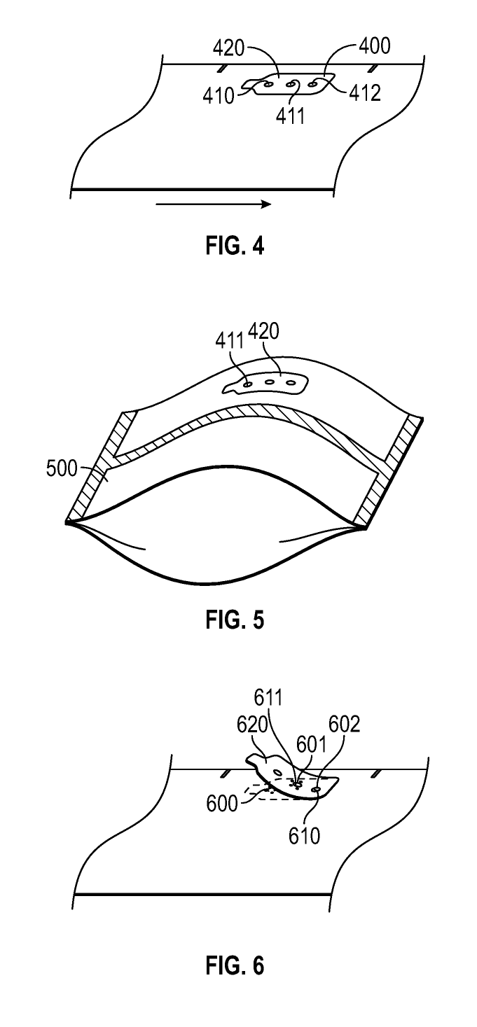

FIG. 4 shows an alternative embodiment, in which the venting mechanism 400 is formed of a number of in-line laser scored circles 410 411, 412, covered by the pressure sensitive adhesive label 420.

FIG. 5 shows forming this web into a pillow pouch package 500, which has the circles created at FIG. 4 as a venting mechanism.

FIG. 6 illustrates similar embodiment as FIG. 4, in which the the material inside the scored circles 600 adheres to the backside 611 of the label 610 when the pressure sensitive adhesive label 610 is lifted. In this way, scored holes such as 600, 601, 602 are formed on the packaging film, but these holes are opened when the pressure sensitive label is removed.

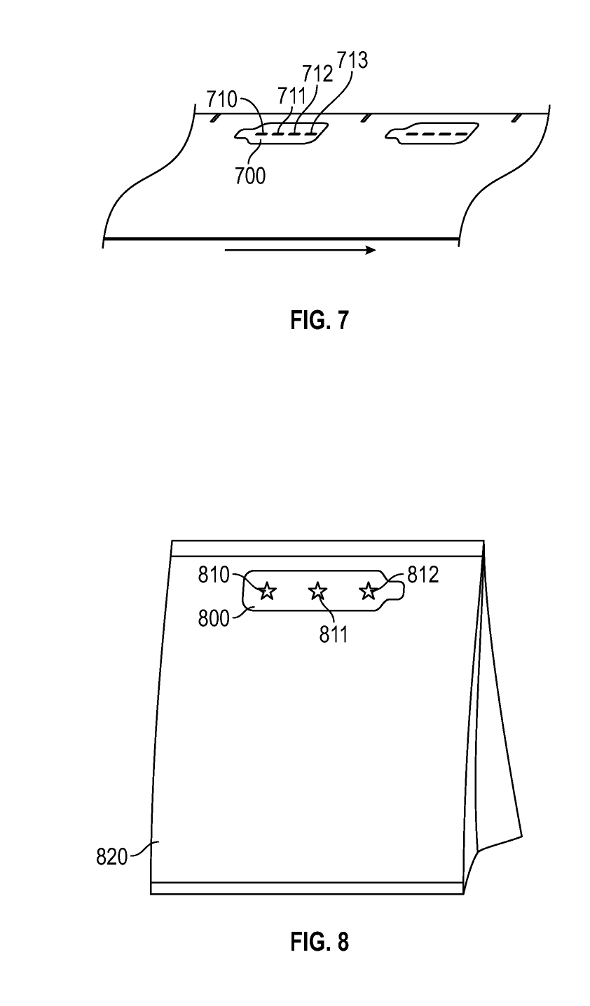

FIG. 7 shows an alternative embodiment where the venting mechanism 700 is formed of a series of linearly-located slits 710 711, 712, 713. This embodiment shows the slits all being located in a line, but it should be understood that the slits can also be offset as in the embodiment of FIG. 2 and or placed in any direction within the packaging film . The slits could be scored or cut partially, or cut completely thru the packaging film.

FIG. 8 shows a stand up pouch with an alternative embodiment in which the venting mechanism is formed in the shape of the venting mechanism 800 is formed in the shape of laser scored stars, 810, 811, 812. These stars can follow any of the previously described embodiments, including the dual row embodiment of FIGS. 2 and 3, the single row embodiment of FIG. 4, and the same removable inside scored portions as of embodiment of FIG. 6.

FIG. 8 shows the package 820 being a vertical or stand up package, however it should be understood that other packages can also be used.

This invention is not limited to any specific label material, adhesives, or kind of material eg carrier liner or linerless label. The label material can be designed to be laser transmissive, meaning the laser bean will not cut thru it, because of its laser barrier properties built in. The laser scored pattern can be done in registration with the label or the PSA label can be applied in registration with the scored pattern.

The PSA label can also be applied before or after the laser or mechanical venting mechanism has been done on the packaging film.

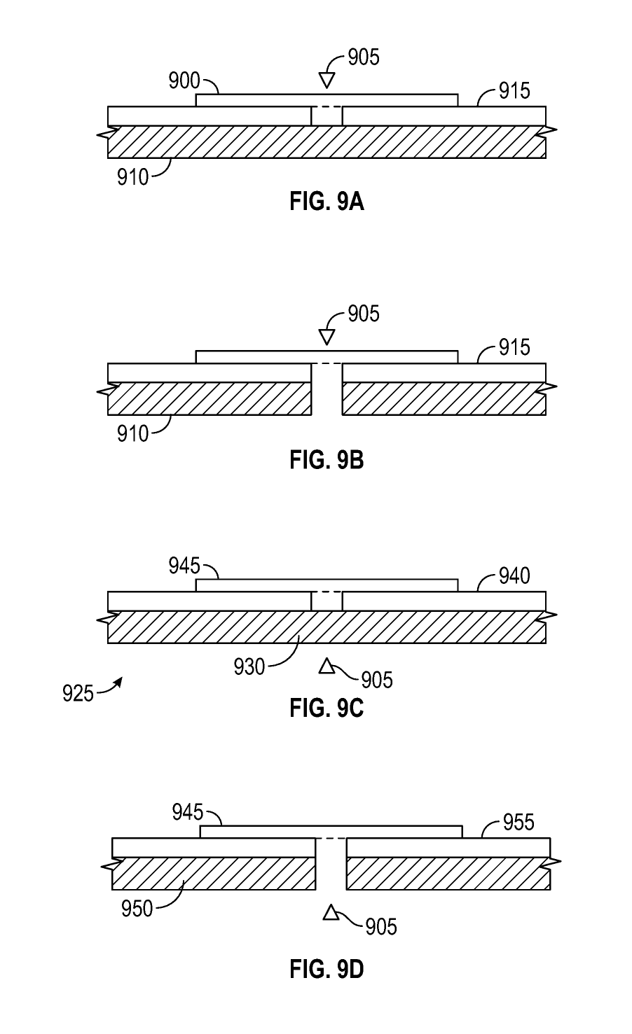

The laser score can be done either from the inner or outer layer of the film as shown in FIGS. 9A-9D.

Different ways of forming the venting mechanism can be used when the label has been applied onto the packaging film prior to creating the venting mechanism. as shown in FIGS. 9 A-9 D. In the FIG. 9 A, the laser scoring is carried out from the outer layer of the packaging film, the laser ray 905 travels through the PSA label 900 onto the packaging film 915 without affecting or cutting the label 900. The PSA label 900 in this enbodiment is transmissive to the laser ray. In this embodiment, The laser ray cuts only the outside layer of the packaging material 915, keeping the barrier layer 910 which is located on the inside layer of the packaging film intact or not affected by the laser ray.

In the embodiment of FIG. 9 B, cuts through both the outer layer 915 and the barrier layer 910 of the packaging film, thus completely opening the packaging film.

The laser ray can also be applied from the sealant or barrier layer side 925 as shown in FIGS. 9 C and 9D resulting on having the same effects on the packaging film as shown on FIGS. 9A and 9B respectively. In FIG. 9C, a barrier layer which is transmissive to lasers is used, and the laser 905 is applied through that barrier layer 930. to cut the package 940, but not to cut the PSA label 945. In FIG. 9D, the laser 905 cuts both the barrier layer 950 and the outside layer 955, but again not the PSA label 945.

In these embodiments, the PSA label that is used can have laser barrier properties built in It should be understood that the venting mechanism of any of the embodiments shown at FIGS. 9A-9D can be done prior to applying the PSA label onto the packaging film.

Laser scoring produces a very consistent score depth, with multiple patterns or shapes, which results in a reliable package that will always open. PSA labels are mass produced, low cost, can be customized according to the unique application, and reliably seal, which keeps the products protected within the package. Label material substrate, size, shape, and adhesive type can easily be selected to any type of packaging film.

In addition the invention is flexible and allows for quick change of laser scoring patterns and shapes, that can be added or modified at any time, and lower cost of manufacture. The laser system and label applicator are readily available equipment and can be integrated into existing packaging film processes without added time or costs. The laser never wears out is also a non-contact process that guarantees a clean process.

Although only a few embodiments have been disclosed in detail above, other embodiments are possible and the inventors intend these to be encompassed within this specification. The specification describes certain technological solutions to solve the technical problems that are described expressly and inherently in this application. This disclosure describes embodiments, and the claims are intended to cover any modification or alternative or generalization of these embodiments which might be predictable to a person having ordinary skill in the art. For example, while the above describes placing the label on the package prior to forming the slits, This can be done, for example, if the material of the PSA is not “laser friendly. In that case, an embodiment can be used where the material is scored first, and then the label is applied to the surface from either the same side of the web as the scoring, or from the opposite side.

the same process could be done using a laser or mechanical die to create the venting mechanism prior to applying the Pressure sensitive label onto the Packaging film.

Single or multiple PSA Labels and scored patterns up can be done within the web width of the packaging film. While the preferred method of cutting the packaging film is using laser technology, however, it could be done using both mechanical or laser scoring/cutting of packaging films, while used in combination with a Label placed on top of the cut/scored area that will maintain the product hermetically sealed prior to cooking.

Laser cutting the packaging film and applying a label that covers the cut/scored area satisfy both issues, a hermetically sealed package prior to cooking, and a reliable venting or steam release mechanism that will allow consumers to safetly cook in the bag. The process can use a computer to control various parts of the operation.

Those of skill would further appreciate that the various illustrative logical blocks, modules, circuits, and algorithm steps described in connection with the embodiments disclosed herein may be implemented as electronic hardware, computer software running on a specific purpose machine that is programmed to carry out the operations described in this application, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer.

The computers described herein may be any kind of computer, either general purpose, or some specific purpose computer such as a workstation. The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

Also, the inventor(s) intend that only those claims which use the words “means for” are intended to be interpreted under 35 USC 112, sixth paragraph. Moreover, no limitations from the specification are intended to be read into any claims, unless those limitations are expressly included in the claims.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A microwave package, comprising
a package, formed of a packaging film, said package being sealed and having a vent area comprising at least one venting mechanism, and a pressure sensitive adhesive label, covering said at least the vent area, and said pressure sensitive adhesive label being removable from the venting mechanism to expose said at least one venting mechanism,
wherein the pressure sensitive adhesive label surrounds the vent area and hermetically seals the package when attached, and opens the venting mechanism to vent when the pressure sensitive label is removed from the package.

2. The microwave package as in claim 1, wherein the at least one vent area comprises multiple different venting mechanisms arranged in multiple different rows, said vent area covered by the pressure sensitive adhesive label when closed attached to packaging film.

3. The microwave package as in claim 1, wherein the vent area comprises multiple different venting mechanisms arranged in a single row, said vent area with said multiple different venting mechanisms being covered by the pressure sensitive adhesive label when the pressure sensitive adhesive label is adhered to the Packaging film.

4. The microwave package as in claim 1, wherein said venting mechanism comprises a perforated venting mechanism defined by an outside perimeter that is perforated, and where removal of the pressure sensitive adhesive label, removes the area on the inside of the perforation to open the entire area of the perforation to vent the package.

5. The microwave package as in claim 4, wherein each of said at least the one vent area comprises scored venting mechanisms in the shape of a circle, with the inside area of the circle being removed when the label is removed.

6. The microwave package as in claim 1, wherein the at least one vent area comprises multiple slits that are covered by a pressure sensitive adhesive label.

7. The microwave package as in claim 4, wherein the at least the one vent area comprises scored venting mechanisms in the shape of a star with the inside area of the star being removed when the label is lifted.

8. A method of forming a microwave package, comprising:
applying a pressure sensitive adhesive label to a packaging film;
forming at least one venting mechanism in the packaging film in a location on the packaging film aligned with the pressure sensitive adhesive label, and
using an area of the packaging film which has the at least one venting mechanism therein and the pressure sensitive adhesive label covering thereover, to form a package which is hermetically sealed while the pressure sensitive adhesive label is attached thereto, and is vented by opening the pressure sensitive adhesive label.

9. The method as in claim 8, wherein said the vent area includes multiple vent mechanisms or features arranged in a single row, all covered by a single pressure sensitive adhesive label.

10. The method as in claim 8 wherein the vent area comprises multiple vents arranged in multiple rows, all covered by a single pressure sensitive adhesive label.

11. The method as in claim 8, wherein the multiple vents comprise circles.

12. The method as in claim 8, wherein the multiple vents are perforated areas whose center portions are removed when the pressure sensitive adhesive label is removed.

13. The method as in claim 8, wherein the at least one vent mechanism comprises at least one slit.

14. The method as in claim 8, wherein the forming vent mechanism comprises using a laser or mechanical die to cut through the packaging film with the pressure sensitive adhesive label attached thereto, without cutting through the pressure sensitive adhesive label.

15. The method as in claim 8, wherein said forming is carried out from the opposite side of the packaging film from the pressure sensitive adhesive layer, without affecting the integrity of or damaging the pressure sensitive adhesive label.

16. The method as in claim 8, wherein said forming is carried out from the same side of the packaging film as the pressure sensitive adhesive layer, without affecting the integrity of or damaging the pressure sensitive adhesive label.

17. The method as in claim 8, wherein said forming is carried out by one of laser scoring, perforating, or die cutting.

18. A microwave package, comprising
a sealed package, formed of a material that has perforated shapes therein, said shapes having a center portion surrounded by a perforation, a pressure sensitive adhesive label, covering all of the perforated shapes, and sticking to the perforated shapes, and removable to remove the central portion of the pattern which sticks to the pressure sensitive adhesive label to form a vent mechanism in the shape,
wherein the pressure sensitive adhesive label surrounds and covers an area of the vents, and hermetically seals the package when the pressure sensitive adhesive label is adhered to the package, and opens the vent mechanisms and removes the center portion of the vent mechanisms, to vent the package when the pressure sensitive label is removed from adhering to the package.

19. A method of forming a microwave package, comprising:
forming multiple venting mechanisms in the packaging film by laser scoring,
perforating, or die cutting an outer layer of the packaging film,
after said forming, applying a pressure sensitive adhesive label to the packaging film to surround and cover an area of the packaging film which has the multiple venting mechanisms, to hermetically seal a package while the pressure sensitive adhesive label is attached thereto, and is then ready to vent by removing the pressure sensitive adhesive label from the venting mechanisms.
